(19) United States
(12) Patent Application Publication
(10) Pub. No.: US 2008/0306702 A1
(43) Pub. Date: Dec. 11, 2008

(54) Method of Rating Wood Product Quality

(75) Inventors: Jeffrey T. Stone, Woodbury, MN (US); Benjamin L. Stone, Inver Grove Heights, MN (US)

Correspondence Address: MOORE & HANSEN, PLLP, 225 SOUTH SIXTH ST, MINNEAPOLIS, MN, 55402, US

(73) Assignee: NAVY ISLAND PLYWOOD, INC., West St. Paul, MN (US)

(21) Appl. No.: 12/095,207

(22) PCT Filed: Nov. 28, 2006
(86) PCT No.: PCT/US06/61306

§ 371 Date: May 28, 2008

Related U.S. Application Data
(60) Provisional application No. 60/740,097, filed on Nov. 28, 2005.

(51) Int. Cl. G01B 5/28

(52) U.S. Cl. 702/81

(57) ABSTRACT

The invention is a method of rating the quality of wood, such as solid wood panels and hardwood veneer faces. The method incorporates multiple and different criteria, reconciling them with each other to produce a cumulative rating. This enables samples having different quality profiles to be compared directly to each other by simply comparing their respective cumulative ratings.

### CROSS-REFERENCE TO RELATED APPLICATION

This application claims the benefit of provisional application Ser. No. 60/740,097 filed Nov. 28, 2005.

### FIELD OF THE INVENTION

This invention concerns methods for rating the quality of assembled wood products, particularly solid wood panels (stave panels) and decorative solid wood veneer faces.

### BACKGROUND

Stave panels and decorative plywood are manufactured using woods cut from many different species of wood (typically hardwood), each of which is notable (and admired) for subtle, unending variation in such qualitative appearance-based criteria as color, grain pattern, figure and the like. In addition, as a naturally occurring product, woods vary in criteria such as number, size and shape of knots and similar “defects” that contribute to the overall perception of the “quality” of the assembled wood product.

This variation presents a practical difficulty in the specification of wood products for commercial purposes, as two people (e.g., buyer and seller) can legitimately disagree as to the quality of a given sample; or as to whether a certain product meets a specified quality level.

The current system for evaluating the quality of assembled veneer faces used in the manufacture of hardwood plywood is established by the Hardwood Plywood Veneer Association (HPVA) and known as the Voluntary Standard for Hardwood and Decorative Plywood. It has been adopted by the American National Standards Institute (ANSI) as the American National Standard for Hardwood and Decorative Plywood. The current version is designated as ANSI/HPVA HP-1-2004. An earlier version was designated as ANSI/HPVA HP-1-2000.

A similar standard used in a related industry is the grading system established by the National Hardwood Lumber Association (NHLA). The NHLA grades only apply to the quality of the lumber prior to any machining or assembly of the individual pieces of wood. The NHLA standard is not applicable to wood veneers, whether assembled or unassembled. The NHLA grade is determined by the amount of usable wood a piece of lumber will yield between knots and splits. The grade is generally not based on the color, grain structure, figure, or general appearance of the wood except for the quantity of open defects.

### SUMMARY OF THE INVENTION

The invention includes a method of rating the quality of appearance of solid wood products, particularly solid wood panels and wood veneers such as those present in stave panels and plywood. The invention also includes products themselves that have been rated by use of the method aspect of the invention. “Solid wood” products may be manufactured from hardwoods or softwoods, although typically veneers are manufactured only from hardwoods. The invention incorporates multiple and different criteria into a single cumulative rating that accommodates variations in quality of appearance due to each criteria. For example, color variation and grain uniformity are two criteria that are (for the most part) independent of each other (i.e., a given piece of wood having any particular degree of color variation may also have a wide range of grain uniformity, and vice versa). The system may be expressed in any convenient scale, e.g., 0-100 “points,” a range of letters such as A-Z, and so on. The use of a cumulative rating enables wood products having differing quality of appearance to be compared directly to each other by simply comparing their respective cumulative ratings.

### BRIEF DESCRIPTION OF THE FIGURE

The FIGURE is a schematic depiction of a color spectrum illustrating how color may be graded in various embodiments of the invention.

### DETAILED DESCRIPTION

To illustrate the invention, the following discussion on occasion deals specifically with post-assembly wood veneer products, and thus includes comparisons to the HPVA standard. The HPVA standard is the only post-assembly wood standard currently in commercial use. The discussion of wood veneer products appearing below should be understood as only an example of the scope of the invention. The invention is applicable to grading systems and standards for solid wood panels.

In general terms, the invention is a system of evaluation in which a “perfect” sample is assigned an arbitrary value (e.g., one hundred) and variations from this value are assigned. There may be as many criteria for evaluating the sample as desired, in accordance with industry practices and/or the benefits of as comprehensive a set of rating criteria as possible.

The ANSI/HPVA standard establishes various grades for many species of hardwood veneers, labeled as AA, A, B, C, D, and E. Within each grade, qualitative and/or quantitative values are established for each of several various grading criteria. For example, for African and Honduras mahogany, the criterion of “Mineral Streaks” ranges in value from “No” for grade AA to “Slight” for grade A, “Occasional” for grade B, and “Yes” for each of grades C-E. The criterion of “Color Variation” ranges in value from “Slight” for grades AA and A, “Moderate” for grade B, and “Yes” for each of grades C-E. Even when the same person is evaluating two samples (and thus presumably the person is consistent in their assessment of what qualitative values such as “slight” mean), difficulties can arise when a sample has different grades for different criteria. For example, a piece of such mahogany veneer that has no mineral streaks (Grade AA) but “Moderate” color variation (Grade B) cannot easily be compared to a second piece of mahogany veneer having “Occasional” mineral streaks (Grade B) but “Slight” color variation (Grade AA). The two pieces can be noticeably different from each other in qualitative appearance.

Another difficulty with standards such as the HPVA/ANSI scheme is the combination of subjective and objective criteria. For example, considering the applicable standards for walnut and cherry, the following criteria are objective: presence or absence of sapwood (and, in “better” grades—such as A and B—sapwood is permitted but the percentage must be agreed upon by buyer and seller, presumably in an objective manner); nominal minimum width of face components; maximum size of conspicuous burls; number and size of blended repaired tapering hairline splits; and so on. Other criteria are subjective: whether color streaks, spots, or variations are “slight”; whether color contrasts at joints are “sharp”; whether burls and pin knots are “small,” and if so, whether they are “conspicuous”; whether mineral streaks are “slight,” whether vine marks or cross bars are “slight” or “occasional”; and so on. The mixture of objective and subjective criteria is particularly troublesome when applied to grades AA, A, and B because in the HPVA standard, the overall grade cannot exceed the lowest grade in any single category. Thus, a difference of opinion or consistency in grading a single subjectively determined criterion may elevate that criterion to the sole reason that an otherwise very attractive (and thus valuable) sample receives only an A or B grade. This is less of a problem in grades C-E because samples in those grades typically have multiple justifications for such low grades.

To resolve this difficulty in comparing or combining the outcomes of evaluating two (or more) unrelated criteria, the invention employs a cumulative rating system in which a sample that is “perfect” (i.e., highest possible rating in all criteria) has a baseline value (e.g. zero or one hundred); each criterion against which the sample is evaluated is assigned a range of values to be added or subtracted from the baseline value. Ratings are reconciled with each other into an overall grade that provides a comprehensive, accurate, and verifiable assessment of the quality of appearance of the sample.

The invention also weighs the relative contributions of different criteria against each other. For example, if color variation is a more important criterion than mineral streaks for the species being considered, the former may be assigned a greater amount or larger range of possible deductions than the latter. This avoids a situation in which a significant decrease in the relatively important criterion is “made up” or negated to a large or complete extent by the absence of any decrease in a relatively less important criterion.

### ILLUSTRATIVE EXAMPLE 1

Consider the extremely simplified situation in which there are only two criteria, color variation and mineral streaks, and that lack of color variation is considered to be more important to the overall quality rating of a sample than lack of mineral streaks. Two different samples of the same species could have the values for such criteria as shown in Table 1-1.

TABLE 1-1

| | | | Value | | | |
|---|---|---|---|---|---|---|
| | Value Attributed | | Attributed to | | | |
| | to Color Variation | | Mineral Streaks | | Overall Grade | |
| Sample | HPVA | Invention | HPVA | Invention | HPVA | Invention |
| #1 | AA | 0 | B | −2 | B | −2 |
| #2 | A | −5 | A | −1 | A | −6 |

Sample #1 is assigned an overall grade of B because in the HPVA standard, the overall grade cannot exceed the lowest grade in any single category. Samples #1 and #2 would be rated in a system like the HPVA standard in a manner that some might find misleading (or at least confusing), because there is no quantitative way to compare a sample like #1, which has excellent color variation but only good mineral streaking, with a sample like #2, which has very good color variation and very good mineral streaking. While neither sample is “perfect,” it is difficult to accurately compare them to each other. By contrast, under a cumulative rating system as employed in the invention, the distinctions between the two samples are easily compared to each other. Thus, Sample #1 has an overall better quality rating (smaller deduction from “perfect”) due to the relatively higher weight given to the criterion of color variation.

### ILLUSTRATIVE EXAMPLE 2

This example illustrates the principles of Example 1 with reference to actual four foot by eight foot cherry veneer panels that were rated by the inventors using the principles of the invention. Panel A had extremely attractive color, grain, and other features, yet was required by the HPVA standard to be rated as only Grade A because of seven conspicuous pin knots with dark centers exceeding 1/16 inch diameter located across the width of the panel. Panel B was somewhat less uniform in color and had a somewhat more wild grain pattern as compared to Panel A. Panel B did not have any conspicuous pin knots, which were defined as pin knots in excess of ¼ inch diameter or those having dark centers larger than 1/16 inch diameter. Panel Be also exhibited significantly more undesirable gum pockets than Panel A, although by subjective interpretation it could have technically been referred to as “occasional” under the HPVA standard. Panel B could have been rated as AA under the HPVA standard, although reasonable minds could have differed as to whether the visible grain structure, the significant number of pin knots, and the amount of gum of the panel of Panel B made it less attractive than Panel A.

The shortcomings of the HPVA standard are illustrated by considering Panel C. As compared to Panel B, the grain structure of Panel C was more consistent and not as wild. There were far fewer instances of dark regions (gum pockets), although not as few as in Panel A. Similarly, the frequency of inconspicuous pin knots was reduced as compared to Panel B. On the whole, it was easily seen that Panel C should have been rated between Panels A and B, but in the HPVA scheme there is no grade between AA (Panel B) and A (Panel A).

### ILLUSTRATIVE EXAMPLE 3

This example illustrates a comprehensive set of criteria according to the principles of the invention. It specifically illustrates that the principles of the invention are applicable to more than one type of cut of veneer within a given species (i.e., plain sawn cherry and quarter sliced cherry). The criteria are grouped into major categories illustrated in Tables 3-1 through 3-9 below, in which type “A” is plain sawn cherry and type “B” is quarter sawn cherry. The specific methods for determining each criterion (as indicated in the remarks included in the table) are preferred but not required. “P.S.” means plain sawn. “L” and “W” refer to length and width, respectively. Rating values of “n/a” indicate that the criterion does not apply to that type of cut of veneer. Other terminology is as defined in ANSI/HPVA HP-1-2000 or ANSI/HPVA HP-1-2004 unless otherwise specified.

Various criteria described in the tables may be, but need not be, illustrated in color photographs for users of the invention. Examples of such criteria include natural character marks (such as pin knots [including the degree], spike knots, burl clusters, burl veins, gum [including size], gum lines [including size], mineral brush, mineral streaks, flars, ice flecks, sapwood, flakes [sycamore grain], mineral grains (shadow grains), and sinew grains); natural grain structure (such as wild grain, slope, wave, loose grain, and grain contast [including the degree of contrast]); leaf matching characteristics (such as barber pole, jail bar, butted crown, manufactured crown, merged crown, owl eyes, and shifted crown); and figure [including the degree of figure] (such as bird's eye, block mottle, curly, fiddleback, popcorn, and ropey). Many criteria are defined with respect to certain percentages of the wood meeting specified conditions (such as lengths, areas, etc.); in these cases, the percentages and conditions are preferred but not required unless specified otherwise. Other criteria may be preferred to be determined with reference to a photograph or illustration, but in general this is not required.

Color is preferably evaluated by comparison to a color spectrum such as that illustrated schematically in the FIGURE. The color spectrum of the FIGURE follows the conventional approach of defining discrete steps between immediately adjacent shades (out of the eighty-four shades shown). The group of twelve shades within the dashed line represents optimum color. The specific number of shades in the entire spectrum, and the specific number in the optimum group, are each preferred but not required. The degree of color variation between adjacent shades may be other than as illustrated in the FIGURE without departing from the principles of the invention.

In commercial application of this example, it is preferred to discount character marks within a given distance from an end of a panel of the veneer (six inches in the most preferred embodiment). The amount of discount is arbitrary, although in the most preferred embodiment, the amount of discount is 50 percent of the full deduction otherwise attributed to such defects. Another preference of the commercial application of this embodiment is to use a sliding scale for valuing deductions, depending on the cumulative amount of deduction involved. For example, a preferred scale assigns the full listed amount of deduction for the first 40 points of deduction, 50 percent of the listed value for the next 20 points of added deduction, and 25 percent of the listed value for any remaining deduction. This is desirable because it ensures that deductions are less critical when applied to lower grades.

The criteria are listed in separate tables captioned 3-1 through 3-9 for convenience of presentation. The entire set of criteria should be considered together to form a comprehensive rating.

TABLE 3-1

| | Type | |
|---|---|---|
| Color | A | B |
| General: Deduct per degree outside of “ideal” color range for overall color between character marks and grain. | 1.5 | 1.5 |
| Color Variation: When more than three shades from the color spectrum appear within five percent of any given area, a | | |
| first degree color variation is present. Each additional shade that appears within the given area increases the degree of | | |
| color variation by one degree. | | |
| Percentage of area with 2^{nd} degree variation (deduct per each percentage of the face showing the color variation) | 0.25 | 0.25 |
| Percentage of area with 3^{rd} degree variation (deduct per each percentage of the face showing the color variation) | 0.5 | 0.5 |
| Percentage of area with 4^{th} degree variation (deduct per each percentage of the face showing the color variation) | 0.75 | 0.75 |
| Percentage of area with 5^{th} degree variation (deduct per each percentage of the face showing the color variation) | 1.25 | 1.25 |
| Percentage of area with 6^{th} degree variation (deduct per each percentage of the face showing the color variation) | 2 | 2 |
| Percentage of area with 7^{th} degree variation (deduct per each percentage of the face showing the color variation) | 3.5 | 3.5 |
| Percentage of area with 8^{th} degree variation (deduct per each percentage of the face showing the color variation) | 7 | 7 |
| Percentage of area with 9^{th} degree variation (deduct per each percentage of the face showing the color variation) | 15 | 15 |
| Percentage of area with 10^{th} degree variation (deduct per each percentage of the face showing the color variation) | 25 | 25 |
| Grain Contrast (1^{st} degree = least contrast, 5^{th} degree = most contrast) | | |
| 1^{st} degree contrast (deduct per level of grain contrast) | 7 | 2 |
| 2^{nd} degree contrast (deduct per level of grain contrast) | 5 | 1 |
| 3^{rd} degree contrast (deduct per level of grain contrast) | 2 | 0 |
| 4^{th} degree contrast (deduct per level of grain contrast) | 0 | 0 |
| 5^{th} degree contrast (deduct per level of grain contrast) | 0 | 0 |

TABLE 3-2

| | Type | |
|---|---|---|
| Cell Structure | A | B |
| Barber Pole: Deduct per degree of separation between adjoining leaves according to the color spectrum. | 1 | 1 |
| Jail Bar: Deduct per degree of separation between adjoining leaves according to the color spectrum. | n/a | 1 |

TABLE 3-3

| | Type | |
|---|---|---|
| | A | B |
| FIG. 1 = least figured; 10 = most figured | | |
| Level 2 figure (deduct per level) | 1 | 1 |
| Level 3 figure (deduct per level) | 1.5 | 1.5 |
| Level 4 figure (deduct per level) | 3 | 3 |
| Level 5 figure (deduct per level) | 5 | 5 |
| Level 6 figure (deduct per level) | 9 | 9 |
| Level 7 figure (deduct per level) | 14 | 14 |
| Level 8 figure (deduct per level) | 16 | 16 |
| Level 9 figure (deduct per level) | 18 | 18 |
| Level 10 figure (deduct per level) | 20 | 20 |
| Flares: A change in the direction of the cells resulting in an angle induced color contrast usually as a result of | | |
| a knot or other inclusion. Deduct per row of flares. | | |
| 1^{st} Degree Flare A single band of figure running the full width of the leaf between 1″-2″ in height. | 0.35 | 0.35 |
| 2^{nd} Degree Flare A single band of figure running the full width of the leaf between 2.1″-3″ in height. | 0.6 | 0.6 |
| 3^{rd} Degree Flare A single band of figure running the full width of the leaf between 3.1″-4″ in height. | 1 | 1 |
| 4^{th} Degree Flare: A single band of figure running the full width of the leaf between 4.1″-5″ in height. | 1.25 | 1.25 |
| 5^{th} Degree Flare: A single band of figure running the full width of the leaf over 5.1″ in height at the widest portion. | 1.75 | 1.75 |
| Blister: A small pocket of figure ranging from ⅛″ to 2″ in diameter as a result of a change in the cell structure changing | | |
| direction. Deduct per blister | | |
| 1^{st} Degree Blister ⅛″-¼″ diameter | 0.03 | 0.03 |
| 2^{nd} Degree Blister ¼″-⅜″ diameter | 0.06 | 0.06 |
| 3^{rd} Degree Blister ⅜″ diameter and greater | 0.1 | 0.1 |

TABLE 3-4

| | Type | |
|---|---|---|
| Grain Structure | A | B |
| Wild Grain (applies to P.S.): More than a 1 inch change in grain direction within any 6 inches of grain, but not within 6″ | 1.5 | n/a |
| of a cathedral peak, unless the cathedral grain within the 6″ of cathedral peak reverses direction more than 90°. The crown | | |
| “peak” must have a width not less than 1″ wide, ½″ from the tip (rounded crowns will not have a six inch wild grain | | |
| allowance). Percentage of wild grain is calculated by identifying the growth ring that is deemed “wild” and using that | | |
| growth ring as the outside perimeter of the area. Deduct for every 10% increase in wild grain over 10% of total face. | | |
| Maximum deduction of 27 points. “A” grade can not have more than 60% wild grain. | | |
| Crown | | |
| Butted Crown: When the inside angle of the intersecting grain at the splice line exceeds 90° or when the grains | 2.5 | n/a |
| merge at the splice line without first forming a cathedral within its respective leaf. If more than 30% of the crown is | | |
| butted or merged, classify it as butted. Deduct per 10% of total splice lines with the butted crown. Minimum | | |
| deduction is 3 points, maximum deduction is 15 points. | | |
| Merged Crown: When no straight grain (quarter grain) separates the heart grain of adjoining leaves, along a splice | 0.65 | n/a |
| line. Straight grain is defined as grain not having a slope greater than 1″ offset over a 12″ length. Deduct per 10% of | | |
| total splice lines with merged crown. Minimum deduction is 3 points, maximum deduction is 10 points. | | |
| Manufactured Crown: When the grain structure of bookmatched leaves forms a pointed symmetrical crown. | 0.75 | n/a |
| Deduct per 10% of length which forms the false crown. Minimum deduction is 5 points, maximum deduction is 7.5 | | |
| points. Manufactured Crown must run at least 60% of the total length or it is graded as adjoining crown. | | |
| Shifted Crown: Deduct for every 10% of the overall length that the crown is offset from the center of the leaf by | 0.5 | n/a |
| more than one inch. | | |
| Sinew Grain: The fine graining between growth rings. Deduct per 10% of face. | 0.5 | n/a |
| Loose Grain | | |
| Loose Grain for Quartered, as it applies to quarters or rift: When the grain is less than three growth rings per inch | n/a | 2 |
| across the width of the leaf measured from the outside edge of the growth ring. Multiply the percentage of area by | | |
| the level of grain contrast by the deduction factor. | | |
| Loose Grain for Plain Sawn: The grain is considered “loose” when the grain is less than one growth ring per 1.5 | 3 | n/a |
| inches across the width of the leaf. Deduct for every 10% of the face that has loose grain. | | |
| Slope Rating: The number of degrees off of a straight vertical that the grain angles (deduct per degree off from 90°) | n/a | 0.25 |
| Grain Bow: When the grain angles away from the edge of the leaf and turns back to the edge at a ratio greater than 1:7 | n/a | 0.35 |
| (14%) | | |
| Flake: Deduct per overall percentage of the face with flake. | 15 | 20 |

TABLE 3-5

| | Type | |
|---|---|---|
| | A | B |
| Pin Knots | | |
| 1^{st} Degree Blending Pin Knots: Actual knot must be less than ⅛″ measured by its longest dimension, with dark | 0.02 | 0.02 |
| center < 1/16″ and maximum flare size less than ¼ sq. inch. Deduct per pin knot. | | |
| 2^{nd} Degree Flared Pin Knots: Actual knot must be less than 5/32″ measured by its longest dimension, with dark | 0.05 | 0.05 |
| center < 1/16″ and maximum flare size less than ½ sq. inch. Deduct per pin knot. | | |
| 3^{rd} Degree Flared Pin Knots: Actual knot must be less than 3/16″ measured by its longest dimension, with dark | 0.15 | 0.15 |
| center < 1/16″ and maximum flare size less than 1 sq. inch. Deduct per pin knot. | | |
| 4^{th} Degree Flared Pin Knots: Actual knot must be less than ¼″ measured by its longest dimension, with dark | 0.3 | 0.3 |
| center <⅛″ and maximum flare size <1.5 sq. inch. Deduct per pin knot. | | |
| 5^{th} Degree Conspicuous Pin Knots: Actual knot must be <¼″ measured by its longest dimension, with dark | 0.6 | 0.6 |
| center < 3/16″ and maximum flare size <2 sq. inch. Deduct per pin knot, | | |
| 6^{th} Degree Large Conspicuous Pin Knots: Actual knot must be <⅜″ measured by its longest dimension, with | 1.5 | 1.5 |
| dark center < 3/16″ and maximum flare size <3 sq. inch. Deduct per pin knot. | | |
| Sound knots or burl clusters over ⅜″ sq. in. (allowable only on grade 50 or lower): Deduct per cumulative square inch. | 3 | 3 |
| (Maximum deduction of 25 points). Deduct per pin knot. | | |
| Spike knots: (applies to quarter sawn/rift only) A pin knot running parallel to the surface of the veneer. Deduct per | | |
| linear inch if light color. Deduct per ¼″ for dark color. Deduct per pin knot. | | |
| Light Spike knot: deduct per inch (same color as the springwood) | 0.25 | 0.25 |
| Brown Spike knot: deduct per inch (same color as the summerwood) | 1 | 1 |
| Black Spike knot: deduct per inch (same color as gum) | 3 | 3 |
| Burl Cluster | | |
| Small Burl Cluster: Grouping of 3-6 pin knots less than 3/16″ diameter within a 0.5 sq. inch area; no dark centers | 0.25 | 0.45 |
| larger than 1/16″. Deduct per cluster. | | |
| Medium burl Cluster: Grouping of 7-10 pin knots less than 3/16″ diameter within a 1 sq. inch area; no dark | 0.75 | 1.25 |
| centers larger than 1/16″. Deduct per cluster. | | |
| Large Burl Cluster: Grouping of 7 or more pin knots less than 3/16″ diameter within a 2 sq. inch area. | 1.5 | 3 |

TABLE 3-6

| | Type | |
|---|---|---|
| Gum Pockets/Gum Lines | A | B |
| Gum Pockets | | |
| Small Gum pocket between 0.02-0.04 sq. in. (approx. ⅛″ W × 7/16″ L with tapered ends) Deduct per pocket. | 0.05 | 0.05 |
| Medium Gum pocket between 0.04-0.10 sq. in. (approx. 3/16″ W × ¾″ L with tapered ends) Deduct per | 0.2 | 0.2 |
| pocket. | | |
| Large Gum pocket over 0.10 sq. in. Deduct per sq. inch of large gum pocket. | 5 | 5 |
| Gum Lines | | |
| Narrow Gum Lines < 1/32″ W (Minimum 1″ long unless separated by less than a 1″ gap between continual lines.) | 0.08 | 0.08 |
| Deduct per linear inch of gum line. | | |
| Medium Gum Lines < 1/16″ W (Minimum 1″ long unless separated by less than a 1″ gap between a continual line) | 0.2 | 0.2 |
| Deduct per linear inch of gum line. | | |
| Wide Gum Lines <⅛″ W (Minimum 1″ long unless separated by less than a 1″ gap between a continual line) | 0.8 | 0.8 |
| Deduct per linear inch of gum line. | | |

TABLE 3-7

| | Type | |
|---|---|---|
| Mineral Marks | A | B |
| Mineral Grain/Shadow Grain: (See Picture) Light colored streaking that shadows the grain. Deduct per linear | 0.1 | 0.1 |
| inch of cumulative mineral grain | | |
| Small Mineral Pockets (0.01-0.02 sq. in.) Deduct per pocket | 0.1 | 0.1 |
| Medium Mineral Pockets (0.02-0.05 sq. in.) Deduct per pocket. | 0.2 | 0.2 |
| Large Mineral Pockets (Over 0.05 sq. in.) Deduct per square inch of large gum pocket. | 0.3 | 0.3 |
| Light Mineral Marks/Mineral brush (See photo) Random marks that do not follow the grain but are same color | 0.75 | 1 |
| as the grain (deduct per cumulative sq. inch) | | |
| Dark Mineral Marks (Mark must be darker than summerwood growth ring. See photo.) (Deduct per | 3 | 4 |
| cumulative sq. inch.) | | |
| Burl Vein: Deduct per sq. inch | 1 | 1 |

TABLE 3-8

| | Type | |
|---|---|---|
| Manufacturing Characteristics | A | B |
| Grain Matching: If multibooked leaves are agreed upon by buyer and seller, no deduction is allowed for figure, grain | 45 | 45 |
| structure, or leaf width. (This is typical of grades 50 or lower.) | | |
| Leaf Width: (Average leaf width for P.S. is 7.5 inches. Average leaf width for quartered is 4 inches.) (Deduct per ¼″ less | 0.35 | 0.5 |
| than average.) | | |
| Rough Grain or Ruptured Grain: (Deduct per square inch of rough grain) | 0.5 | 0.5 |
| Blended Repaired Tapering Hairline Splits: (Deduct per inch of repaired splits over 6″ × 1/32″) | 1 | 1 |
| Splice Line Offset/Parallel: Deduct per ½″ offset per 8′ (first ½″ allowable without deduction) Outside leafs will be a | 2 | 3 |
| different size to allow for edge trim | | |

TABLE 3-9

| | Type | |
|---|---|---|
| Miscellaneous | A | B |
| Average linear feet of sequence size (72 linear feet for plain slice, 16 linear feet for quartered slice) | | |
| Credit allowed for every 1 percent increase of the actual sequence size over the posted average sequence size. A portion | 1 | 1 |
| of this credit may be applied to all panels or a single panel, but not to exceed 15 points. | | |

### ILLUSTRATIVE EXAMPLE 4

Five samples of plain sliced cherry veneer panels (designated A-E) were rated according to an embodiment of the invention in which cumulative deductions were subtracted from one hundred to arrive at the overall rating. The results are shown in Table4-1.

TABLE 4-1

Deductions

| Criterion | A | B | C | D | E |
|---|---|---|---|---|---|
| Overall Color | 3.00 | 3.00 | 0.00 | 3.00 | 0.00 |
| Color Variations | 0.00 | 0.00 | 7.50 | 0.00 | 0.00 |
| Grain Structure | 5.00 | 9.50 | 8.80 | 9.33 | 6.00 |
| Figure | 0.00 | 1.50 | 0.00 | 3.00 | 0.00 |
| Flares | 1.75 | 0.00 | 0.00 | 0.00 | 0.00 |
| Flake | 0.00 | 0.00 | 0.00 | 0.00 | 0.00 |
| Barber Pole | 0.00 | 0.00 | 0.00 | 0.00 | 0.00 |
| Pin Knots | 1.20 | 1.00 | 0.00 | 2.28 | 0.77 |
| Gum Pockets | 0.00 | 0.81 | 0.75 | 0.00 | 0.00 |
| Mineral Streaks | 0.00 | 0.00 | 0.00 | 0.00 | 12.11 |
| LeafWidth | 1.75 | 0.00 | 0.00 | 0.00 | 0.00 |
| Total Deductions | 12.70 | 15.81 | 17.05 | 17.61 | 18.88 |
| Overall Rating | 87.30 | 84.19 | 82.95 | 82.39 | 81.12 |

The results illustrate clearly how samples of the same species and cut may have differing ratings for each of several criteria. Combining the ratings from all the criteria together into a cumulative according to the principles of the invention allows for such differences to be easily considered and reconciled together.

### GENERAL CONSIDERATIONS

When applied to wood veneer faces, the invention is applicable to veneers manufactured by any of the following types of cut, without any loss of generality: rotary, quarter sliced, rift-cut, plain sliced (or flat cut), half round sliced, or lengthwise sliced veneers.

Without any loss of generality, the invention may be implemented for other species of wood besides those discussed above. The selection of species will generally dictate the selection of criteria used to evaluate the quality of the sample being evaluated. Suitable species include, but are not limited to: hardwoods (i.e., the wood of a deciduous or broad-leaf tree) such as cherry, birch, beech, chestnut, hickory, maple, oak, walnut, gum, and poplar, and softwoods (i.e., the wood of an evergreen or needle bearing coniferous tree) such as pine, spruce, or fir.

Without any loss of generality, the invention may be implemented in an embodiment in which a “perfect” sample is assigned a rating of zero, and deviations from perfect are added to (or subtracted from) this value in a cumulative fashion.

The invention is applicable to products manufactured from solid wood (hardwood or softwood), including products made from (but not necessarily requiring) veneers. Such products include, without limitation, plywood (such as that used to manufacture paneling, cabinets, chairs, chests, pianos and organs, desk tops, doors, and similar products); engineered flooring; furniture and related products (e.g., chairs, kitchen, bathroom and other cabinets; computer and other furniture; television, stereo, and other cabinets; tables; chests; lamps); wall and other plaques; and the like.

In the discussion above, “sample” should be understood to mean an assembled unit, i.e., a panel forming the workpiece for a product, a component of such product once assembled or when ready to be assembled, and the like. “Sample” should also be understood to mean a piece of material being considered for matching to another piece so that the two may be assembled together into a single assembled unit that appears to be manufactured from a continuous piece of wood. For example, it may be necessary to match individual portions of veneer so that they may be combined into a single large panel having as much consistency of appearance as possible.

The invention may be used as a complete rating system replacing the HPVA-HP-1 standard, or it may be used as an additional rating system to increase the accuracy of use of the HPVA-HP-1 standard.

To the extent any of this discussion of the preferred embodiments (or the literal scope of the appended claims) implies human observation and evaluation without expressly limiting the scope of the invention to the same, such observation and evaluation may be performed by automated or computerized devices and methods, whether currently existing or developed in the future.

Publications setting forth preferred embodiments of the invention are available from Navy Island Plywood of West St. Paul, Minn., USA and are incorporated by reference. Such publications include those applicable to species of (among others) oak, walnut, maple, cherry, birch, beech and mahogany.

The preceding discussion employs various preferred embodiments of the invention for purposes of illustration only, as the full extent of the invention is defined only by the following claims.

1. A method of rating the visual quality of a plurality of pieces of solid wood product, comprising, for each of the pieces:
a) evaluating a plurality of factors, each of which indicates an aspect of visual quality of each piece;
b) reconciling all evaluated factors to a cumulative rating representative of the overall visual quality of each piece; and
c) assigning a same cumulative rating to non-identical pieces having a same visual quality.

2. The method of claim 1, in which the rating is a scale ranging between zero and one hundred.

3. The method of claim 1, in which the solid wood product is manufactured from a hardwood.

4. The method of claim 1, in which the solid wood product is manufactured from a softwood.

5. The method of claim 1, in which the solid wood product is selected from the group consisting essentially of cherry, birch, beech, chestnut, hickory, maple, oak, walnut, gum, poplar, pine, spruce, and fir.

6. The method of claim 1, in which the solid wood product is a wood panel.

7. The method of claim 1, in which the solid wood product comprises a wood veneer.

8. The method of claim 7, in which the wood veneer comprises a veneer selected from the group consisting of rotary, quarter sliced, rift-cut, plain sliced, half round sliced, and lengthwise sliced veneers.

9. The method of claim 1, in which at least one factor is selected from the group consisting essentially of color, color variation, grain structure, grain contrast, jail bar, cell structure, figure, flares, blister, wild grain, butted crown, merged crown, manufactured crown, shifted crown, sinew grain, loose grain, grain bow, missing crown, wave value, flake, barber pole, pin knots, sound knots, spike knots, burl clusters, gum pockets, gum lines, mineral marks, streaks, and leaf width.

10. A method of comparing multiple samples of solid wood products to each other, comprising:
a) rating visual quality of each sample using a cumulative value reflecting a plurality of criteria;
b) comparing the respective cumulative values of each sample to each other; and
c) assigning a same cumulative rating to non-identical pieces having a same visual quality.

11. The method of claim 10, in which the rating is a scale ranging between zero and one hundred.

12. The method of claim 10, in which the samples are manufactured from a hardwood.

13. The method of claim 10, in which the samples are manufactured from a wood selected from the group consisting essentially of cherry, birch, beech, chestnut, hickory, maple, oak, walnut, gum, poplar, pine, spruce, and fir.

14. The method of claim 10, in which the samples are manufactured from a softwood.

15. The method of claim 10, in which the samples are wood panels.

16. The method of claim 10, in which the samples each comprise a wood veneer.

17. The method of claim 16, in which the wood veneer comprises a veneer selected from the group consisting of rotary, quarter sliced, rift-cut, plain sliced, half round sliced, and lengthwise sliced veneers.

18. The method of claim 10, in which at least one factor is selected from the group consisting essentially of color, color variation, grain structure, grain contrast, jail bar, cell structure, figure, flares, blister, wild grain, butted crown, merged crown, manufactured crown, shifted crown, sinew grain, loose grain, grain bow, missing crown, wave value, flake, barber pole, pin knots, sound knots, spike knots, burl clusters, gum pockets, gum lines, mineral marks, streaks, and leaf width.

19. The method of claim 10, in which the samples are assembled together into a single assembled unit.

20. The method of claim 10, in which the samples are individual portions of wood veneer that may be combined into a single panel.

21. A post-assembly wood product, comprising wood which has been assigned a cumulative value reflecting a plurality of criteria related to quality of appearance of the wood and selected from non-identically appearing wood having the same cumulative rating.

22. The product of claim 21, in which the cumulative value ranges between zero and one hundred.

23. The product of claim 21, in which the product comprises a hardwood.

24. The product of claim 21, in which the product comprises a softwood.

25. The product of claim 21, in which the solid wood product comprises a wood selected from the group consisting essentially of cherry, birch, beech, chestnut, hickory, maple, oak, walnut, gum, poplar, pine, spruce, or fir.

26. The product of claim 21, in which the product is a wood panel.

27. The product of claim 21, in which the product comprises a wood veneer.

28. The product of claim 21, in which at least one criterion is selected from the group consisting essentially of color, color variation, grain structure, grain contrast, jail bar, cell structure, figure, flares, blister, wild grain, butted crown, merged crown, manufactured crown, shifted crown, sinew grain, loose grain, grain bow, missing crown, wave value, flake, barber pole, pin knots, sound knots, spike knots, burl clusters, gum pockets, gum lines, mineral marks, streaks, and leaf width.

29. The product of claim 21, in which the product is selected from the group consisting essentially of plywood, cabinet, chair, chest, piano, organ, desktop, door, engineered flooring, lamp, and plaque.
